(19) United States
(12) Patent Application Publication
(10) Pub. No.: US 2014/0355410 A1
(43) Pub. Date: Dec. 4, 2014

(54) Systems and Methods for Data Transmission

(71) Applicant: Tencent Technology (Shenzhen) Company Limited, Shenzhen (CN)

(72) Inventors: Xinhai Zeng, Shenzhen (CN); Kun Guan, Shenzhen (CN)

(73) Assignee: Tencent Technology (Shenzhen) Company Limited, Shenzhen (CN)

(21) Appl. No.: 14/220,798

(22) Filed: Mar. 20, 2014

Related U.S. Application Data
(63) Continuation of application No. PCT/CN2013/088645, filed on Dec. 5, 2013.

(30) Foreign Application Priority Data
Jun. 4, 2013 (CN) 201310217803.8

(51) Int. Cl. H04L 12/26; H04L 12/939

(52) U.S. Cl. CPC H04L 43/16; H04L 49/552
USPC 370/216

(57) ABSTRACT

Systems and methods are provided for data transmission. For example, first data to be sent is obtained; the first data is sent to a reception terminal; second data related to a packet-loss rate returned by the reception terminal is received; and in response to the packet-loss rate exceeding a pre-determined threshold, at least a portion of the first data is sent multiple times.

### CROSS-REFERENCES TO RELATED APPLICATIONS

This application claims priority to Chinese Patent Application No. 201310217803.8, filed Jun. 4, 2013, incorporated by reference herein for all purposes.

### BACKGROUND OF THE INVENTION

Certain embodiments of the present invention are directed to computer technology. More particularly, some embodiments of the invention provide systems and methods for communication technology. Merely by way of example, some embodiments of the invention have been applied to data transmission. But it would be recognized that the invention has a much broader range of applicability.

Currently, the Internet has become an indispensable communication channel in people's daily lives. Through various applications, users can make voice calls or video calls through the Internet. Usually, audio data or video data can be sent using User Data Protocol (UDP). However, the data transmission process is often affected by network media and links. Oftentimes, data loss occurs in the process of transmission. For example, when audio data from a sender is lost in the process of transmission, a receiver cannot receive such audio data and the audience may experience a sound lag.

Hence it is highly desirable to improve the techniques for data transmission.

### BRIEF SUMMARY OF THE INVENTION

According to one embodiment, a method is provided for data transmission. For example, first data to be sent is obtained; the first data is sent to a reception terminal; second data related to a packet-loss rate returned by the reception terminal is received; and in response to the packet-loss rate exceeding a pre-determined threshold, at least a portion of the first data is sent multiple times.

According to another embodiment, a data transmission device includes: an acquisition module, a transmitting module, a receiving module and an adjustment module. The acquisition module is configured to obtain first data to be sent. The transmitting module is configured to send the first data to a reception terminal. The receiving module is configured to receive statistical data related to a packet-loss rate returned by the reception terminal. The adjustment module is configured to, in response to the packet-loss rate exceeding a pre-determined threshold, cause the transmitting module to send at least a portion of the first data multiple times.

According to yet another embodiment, a method is provided for data transmission. For example, first data to be sent is obtained at the client; the first data is sent by the client to a reception terminal based on at least information associated with a network protocol; second data related to a packet-loss rate is computed by the reception terminal based on at least information associated with the first data; the second data related to the packet-loss rate is sent by the reception terminal to the client; whether the packet-loss rate exceeds a pre-determined threshold is determined by the client based on at least information associated with the second data; and in response to the packet-loss rate exceeding the pre-determined threshold, at least a portion of the first data is sent by the client multiple times.

In one embodiment, a data transmission system includes: an acquisition module, a transmitting module, a statistics module, a return module, a receiving module and an adjustment module. The acquisition module is configured to obtain at a client first data to be sent. The transmitting module is configured to send the first data to a reception terminal based on at least information associated with a network protocol. The statistics module within the reception terminal is configured to compute second data related to a packet-loss rate based on at least information associated with the first data. The return module is configured to return the second data related to the packet-loss rate to the client. The receiving module is configured to receive the second data related to the packet-loss rate returned by the reception terminal. The adjustment module is configured to, in response to the packet-loss rate exceeding a pre-determined threshold, cause the transmitting module to send at least a portion of the first data multiple times.

In another embodiment, a non-transitory computer readable storage medium includes programming instructions for data transmission. The programming instructions are configured to cause one or more data processors to execute certain operations. For example, first data to be sent is obtained; the first data is sent to a reception terminal; second data related to a packet-loss rate returned by the reception terminal is received; and in response to the packet-loss rate exceeding a pre-determined threshold, at least a portion of the first data is sent multiple times.

In yet another embodiment, a non-transitory computer readable storage medium includes programming instructions for data transmission. The programming instructions are configured to cause one or more data processors to execute certain operations. For example, first data to be sent is obtained at the client; the first data is sent by the client to a reception terminal based on at least information associated with a network protocol; second data related to a packet-loss rate is computed by the reception terminal based on at least information associated with the first data; the second data related to the packet-loss rate is sent by the reception terminal to the client; whether the packet-loss rate exceeds a pre-determined threshold is determined by the client based on at least information associated with the second data; and in response to the packet-loss rate exceeding the pre-determined threshold, at least a portion of the first data is sent by the client multiple times.

For example, the systems and methods described herein can be configured to keep a packet-loss rate within an acceptable range so as to enhance the reliability of network data transmission and enhance audio quality and/or video quality.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a device for data transmission according to one embodiment of the present invention.

FIG. 2 is a simplified diagram showing an environment for data transmission according to one embodiment of the present invention.

FIG. 3 is a simplified diagram showing a method for data transmission according to one embodiment of the present invention.

FIG. 4 is a simplified diagram showing a device for data transmission according to one embodiment of the present invention.

FIG. 5 is a simplified diagram showing a device for data transmission according to another embodiment of the present invention.

FIG. 6 is a simplified diagram showing a system for data transmission according to one embodiment of the present invention.

### DETAILED DESCRIPTION OF THE INVENTION

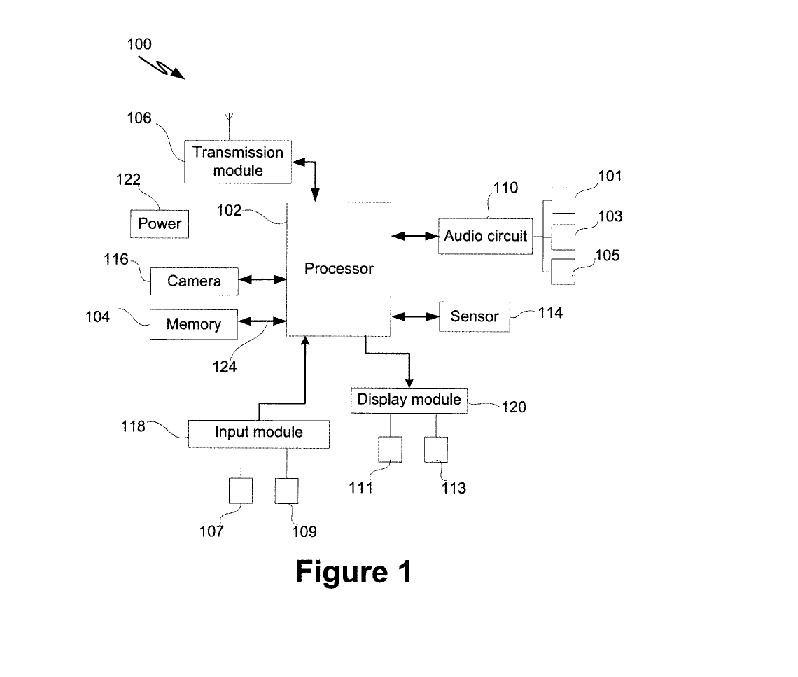

FIG. 1 is a simplified diagram showing a device for data transmission according to one embodiment of the present invention. This diagram is merely an example, which should not unduly limit the scope of the claims. One of ordinary skill in the art would recognize many variations, alternatives, and modifications.

According to one embodiment, the electronic device 100 includes a desktop computer, a laptop computer, a smart phone, a personal digital assistant, a tablet, etc. For example, one or more intelligent operating systems are installed or run on the device 100. As shown in FIG. 1, the electronic device 100 includes one or more processors 102, a memory device 104, a transmission module 106, an audio circuit 110, a sensor 114, a camera module 116, an input module 118, a display module 120, and a power source 122, in some embodiments. For example, the electronic device 100 may also include more or fewer components than what are shown in FIG. 1 or have a configuration that differs from that shown in FIG. 1.

According to another embodiment, in relation to the processors 102, other components are considered peripherals, and the processors 102 are coupled to these peripherals through one or more peripheral interfaces 124. For example, the peripheral interfaces 124 can be realized based on the following standards: Universal Asynchronous Receiver/Transmitter (UART), General Purpose Input Output (GPIO), Serial Peripheral Interface (SPI) and Inter-Integrated Circuit (I2C). In another example, the peripheral interfaces 124 may only include a bus. In yet another example, the peripheral interfaces 124 may also include one or more controllers, such as display controllers configured to connect a liquid crystal display panel and/or storage controllers configured to connect memory devices. In yet another example, such controllers can also be detached from the peripheral interfaces 124 and integrated into the processors 102 or a corresponding peripheral.

According to yet another embodiment, the memory device 104 can be configured to store software programs and modules, such as the program instructions/modules for data transmission. For example, through running the software programs and modules stored in the memory device 104, the processors 102 executes various functional applications and data processing, hence launching relevant applications in the electronic device 100. In another example, the memory device 104 may include high-speed random access memory devices, as well as non-volatile memory devices such as one or more magnetic storage devices, flash memory or other non-volatile, solid state memory devices. In yet another example, the memory device 104 may further include memory devices for a remote setup of the processors 102, and these remote memory devices can be connected to the electronic device 100 via a network (e.g., the Internet, a company intranet, a local area network, a mobile communication network, or other suitable networks).

In one embodiment, the transmission module 106 is configured to receive or send data through a network (e.g., a wired network, a wireless network). For example, the transmission module 106 includes a Network Interface Controller (NIC) that can be connected to other network devices, routers or modems using a network cable, enabling communication with the Internet. In another example, the transmission module 106 includes a Radio Frequency (RF) module configured to receive and send electromagnetic waves so as to achieve interchange of electromagnetic waves and electrical signals and enable communication with a communication network or other equipment. In another example, the RF module may include various existing circuit elements for performing certain functions, such as antennas, RF transceivers, digital signal processors, encryption/decryption chips, subscriber identity module (SIM) cards, memory devices, etc. In yet another example, the RF module may communicate with various networks such as the Internet, a company intranet, a wireless network, or communicate with other equipment through a wireless network. In yet another example, the wireless network may include the cell phone network, wireless LAN or metropolitan area network. In yet another example, the wireless network may use various communication standards, protocols and technologies, including but not limited to the Global System for Mobile Communication (GSM), Enhanced Data GSM Environment (EDGE), wideband code division multiple access (W-CDMA), code division access (CDMA), time division multiple access (TDMA), Wireless Fidelity (WiFi) (such as the standards of the U.S. Institute of Electrical and Electronic Engineers, IEEE 802.11a, IEEE 802.11b, IEEE802.11g and/or IEEE 802.11n), voice over internet protocol (VoIP), Worldwide Interoperability for Microwave Access (Wi-Max), other protocols used for email, instant messaging and short messages, as well as any other appropriate communication protocols, and even protocols that have yet been developed at the moment.

In another embodiment, the audio circuit 110, a speaker 101, an audio jack 103 and/or a microphone 105 provide an audio interface between users and the electronic device 100. For example, the audio circuit 110 receives audio data from the processors 102, converts the audio data into electrical signals, and transmits the electrical signals to the speaker 101. In another example, the speaker 101 then converts the electrical signals into sound waves that can be heard by users. In yet another example, the audio circuit 110 also receives electrical signals from the microphone 105, converts the electrical signals into audio data, and transmits the audio data to the processors 102 for further processing. As an example, audio data can be obtained from the memory device 104 or through the transmission module 106. In addition, audio data can also be stored in the memory device 104 or sent through the transmission module 106.

In yet another embodiment, the sensor 114 includes: optical sensors, motion sensors and other sensors. For example, optical sensors may also include ambient light sensors and proximity sensors. As an example, the ambient light sensors can detect the intensity of ambient light and the processors 102 then executes some modules that use the output of the ambient light sensors to automatically adjust the display output. As another example, the proximity sensors can shut down the display output when the electronic device 100 is brought close to users. In another example, as a type of motion sensors, a gravity acceleration sensor can detect the magnitude of acceleration in various directions (usually triaxial). When stationary, the gravity acceleration sensor can detect the magnitude and direction of gravity and can be used in mobile applications of gesture recognition (such as switching between portrait and landscape orientations, relevant games and magnetometer calibration gesture) and functions related to vibration recognition (such as pedometer and tapping). In yet another example, other sensors such as gyroscope, barometer, hygrometer and thermometer, can also be used in the electronic device 100.

In yet another embodiment, the camera module 116 is configured to take photographs and videos. For example, the photographs and videos taken can be stored in the memory device 104 or sent through the transmission module 106. In another example, the camera module 116 includes specifically a lens module, an image sensor, a flash light, etc. In yet another example, the lens module is configured to form an image of the photographed target, and the image is then projected onto the image sensor. The image sensor is configured to receive light rays from the lens module, achieve photography and record the image information. Specifically, the image sensor can be actualized based on the Complementary Metal Oxide Semiconductor (CMOS), Charge-coupled Device (CCD) or other image sensory principles. The flash light is configured to provide exposure compensation during filming. For example, the flash light used for the electronic device 100 can be the Light Emitting Diode (LED) flash light.

In yet another embodiment, the input module 118 is configured to receive the character information being entered and the signal entered using the keyboard, mouse, joystick, optical or trackball that is related to the user settings and control function. Specifically, the input module 118 may include a button 107 and a touch surface 109. For example, the button 107 may include the character keys used to enter characters and control buttons used to trigger control functions. As an example, the control buttons include the “return to the main screen” button, on/off button, camera button, etc. As another example, the touch surface 109 may collect the user's touch operations on or near it (such as the operations executed by the user with his/her fingers, stylus or any appropriate object or auxiliary item on or near the touch surface 109), and launch the relevant connected devices based on pre-defined programs. In another example, the touch surface 109 may optionally include two parts, namely, a touch detection device and a touch controller. In yet another example, the touch detection device detects the user's touch orientation, detects the signals sent by the touch operations, and sends the signals to the touch controller. In yet another example, the touch controller receives the touch information from the touch detection device, and converts it into contact coordinates and then sends them to the processors 102. In yet another example, the touch controller can also receive and execute the commands issued by the processors 102. In addition, the touch surface 109 can be actualized using the resistive, capacitive, infrared, surface acoustic wave and many other modes. Besides the touch surface 109, the input module 118 may also include other input devices, such as, a physical keyboard, a trackball, a mouse, a joystick, or other suitable input devices.

In some embodiments, the display module 120 is configured to display information entered by the user, information given to the user and various graphical user interfaces of the electronic device 100. For example, these graphical user interfaces may include graphics, text, icons or videos, or any combination thereof. In another example, the display module 120 includes a display panel 111 which may include a Liquid Crystal Display (LCD), Organic Light-Emitting Diode Display (OLED) Display Panel, or Electro-Phoretic Display (EPD). In yet another example, the touch surface 109 can be placed on and integrated with the display panel 111. In yet another example, the display module 120 may also include other display devices such as a projection display device 113 which may include some parts used for projection such as the lens group.

In certain embodiments, the power source 122 is configured to supply power to the processors 102 and all other components. Specifically, the power source 122 may include a power management system, one or more power sources (such as battery or alternating current), a charging circuit, a power failure detector circuit, an inverter, a power status indicator light and any other components that are related to power generation, management and distribution in the electronic device 100.

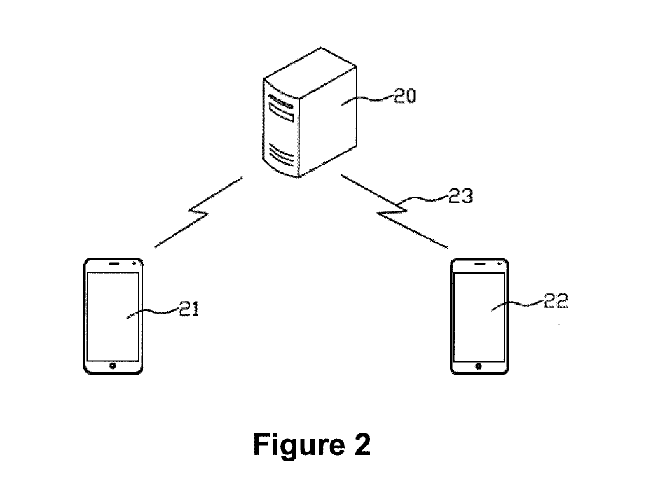

FIG. 2 is a simplified diagram showing an environment for data transmission according to one embodiment of the present invention. This diagram is merely an example, which should not unduly limit the scope of the claims. One of ordinary skill in the art would recognize many variations, alternatives, and modifications. As shown in FIG. 2, a first client 21 and a second client 22 are connected to a server 20 through a network 23, in some embodiments. For example, the server 20 includes a voice server or a video server. As an example, the first client 21 and/or the second client 22 includes the device 100. As another example, the first client 21 and/or the second client 22 communicate with the network 23 through a transmission module (e.g., the transmission module 106).

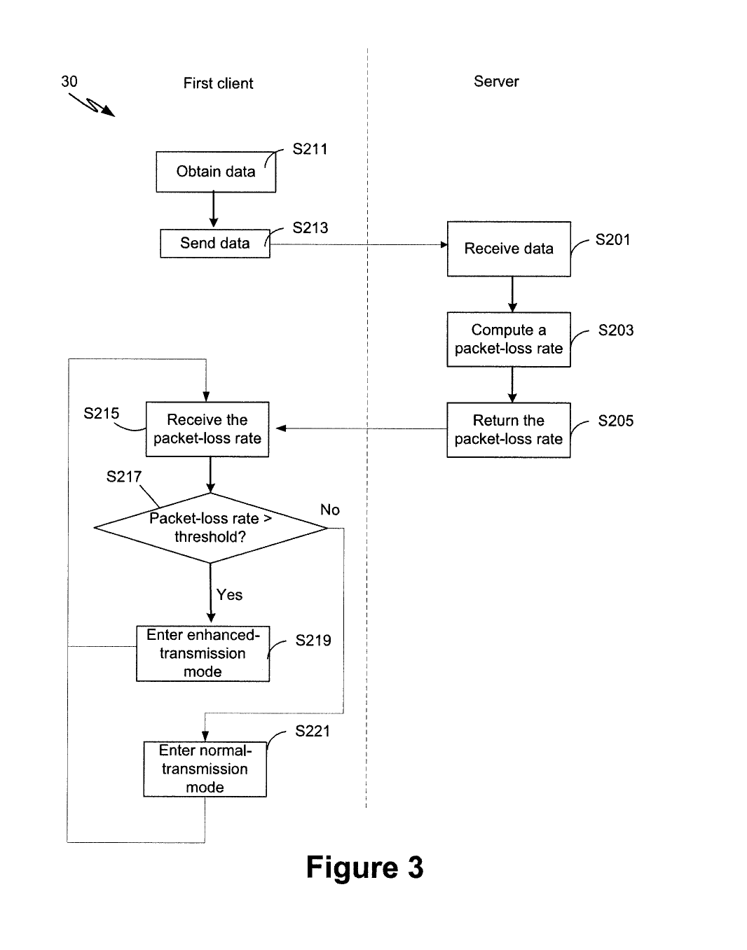

FIG. 3 is a simplified diagram showing a method for data transmission according to one embodiment of the present invention. This diagram is merely an example, which should not unduly limit the scope of the claims. One of ordinary skill in the art would recognize many variations, alternatives, and modifications. The method 30 includes at least the process S201-S221.

According to one embodiment, the process S211 includes: obtaining the data to be sent. For example, the data to be sent can be audio data. As an example, the first client 21 can record voice signals entered through the microphone 105, and convert the voice signals into audio data through the audio circuit 110. In another example, the data to be sent can be video data. The first client 21 can record video signals through the camera module 116, and convert the video signals into video data. In yet another example, the data to be sent can also be stored in advance in the memory device 104. In yet another example, the obtaining the data to be sent includes extracting the data from a file. The data to be sent can also be processed through conversion operations such as compression or encryption, in some embodiments.

According to another embodiment, the process S213 includes: sending the data to be sent to a reception terminal based on a network protocol. The network protocol can, for example, be a User Data Protocol (UDP). As an example, the reception terminal corresponds to the server 20. For example, in Peer to Peer (P2P) transmission, the reception terminal can be another electronic device such as the second client 22. In another example, the data to be sent can be sent through the transmission module 106.

According to yet another embodiment, the process S215 includes: receiving statistical data associated with a packet-loss rate returned by the reception terminal. For example, the packet-loss rate refers to the number of lost data packets as a percentage of the total number of data packets to be sent. As an example, the statistical data associated with the packet-loss rate can be the packet-loss rate, or data used to compute the packet-loss rate such as the number of data packets that are received.

According to yet another embodiment, the process S217 includes: determining whether the packet-loss rate exceeds a pre-determined threshold. For example, if the packet-loss rate exceeds a pre-determined threshold, the process S219 is executed. Otherwise the process S221 is executed. In another example, the pre-determined threshold can be 3%. In yet another example, the process S219 includes: entering an enhanced-transmission mode.

In one embodiment, the enhanced-transmission mode refers to transmitting the data to be sent multiple times. The number of repeated transmission can be set based on specific needs. For example, the packet-loss rate can be reduced significantly with two repeated transmissions. As an example, under extremely poor network conditions, the number of repeated transmissions can be gradually increased until the packet-loss rate is reduced to an acceptable range which is lower than the pre-determined threshold.

In another embodiment, the enhanced-transmission mode refers to transmitting a portion of the data to be sent multiple times. For example, a value of 50% can be pre-determined, and only 50% of the data packets in the data to be sent are sent multiple times. As an example, the data packets of this pre-defined percentage can be evenly distributed in all the data packets in the data to be sent. As such, the packet-loss rate is reduced to the acceptable range under most situations and the network traffic is reduced, in some embodiments.

In certain embodiments, the method 30 further includes: detecting whether the data to be sent is valid. For example, if the data to be sent is valid, the data is sent multiple times. Otherwise the data is sent based on a normal-transmission mode, e.g., sending all data packets included in the data only once. In another example, if audio data contains only background sound data, its impact on the quality of voice calls is minimal and a high packet-loss rate will not affect the quality of voice calls. The audio data can be considered invalid and even if the packet-loss rate exceeds the pre-determined threshold, such audio data is not sent repeatedly so that the network traffic can be reduced. In yet another example, if one or more images in video data remains unchanged for a long period of time, such images in the video data are considered invalid and even if the packet-loss rate exceeds the pre-determined threshold, such data is not sent repeatedly so that the network traffic is reduced.

In some embodiments, the process S221 includes: entering a normal-transmission mode. For example, the normal-transmission mode is different from the enhanced-transmission mode, and occupies smaller network traffic as compared to the enhanced-transmission mode. In another example, the normal-transmission mode refers to sending all the data packets only once. In yet another example, the normal-transmission mode refers also to sending a portion of the data packets multiple times, but this portion of data packets is of a smaller percentage than the data packets sent repeatedly in the enhanced-transmission mode.

In certain embodiments, after the process S219 and the process 221, the process S215 is executed, so that the transmitting mode can be adjusted based on the latest statistical data associated with the packet-loss rate returned by the server 20. For example, the data transmission process at the server 20 includes: the process S201 for receiving data sent by the first client 21, and the process S203 for computing the packet-loss rate based on the received data. As an example, the packet-loss rate refers to the number of lost data packets as a percentage of the total number of data packets that are sent. In another example, the server 20 can easily compute the number of data packets received. If the packet-loss rate is to be computed, the number of data packets that are sent is needed. In yet another example, the number of data packets that are sent can be obtained through an independent data packet sent by the first client 21 to the server 20, or obtained by the server 20 by parsing the control information within the received data packets. For example, each data packet contains an identifier, and the identifiers of different data packets are continuous. Therefore, the number of data packets can be obtained by subtracting the smallest identifier from the largest identifier, in some embodiments. For example, the data transmission process at the server 20 further includes the process S205 for returning the computed packet-loss rate to the first client 21. Specifically, the packet-loss rate can be returned directly, or other data that can be used to compute the packet-loss rate, such as the received number of data packets, can be returned to the first client 21.

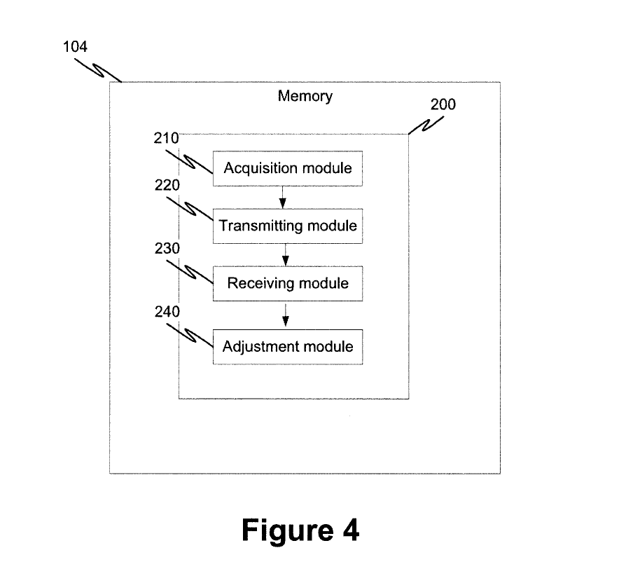

FIG. 4 is a simplified diagram showing a device for data transmission according to one embodiment of the present invention. This diagram is merely an example, which should not unduly limit the scope of the claims. One of ordinary skill in the art would recognize many variations, alternatives, and modifications. The data-transmission device 200 includes: an acquisition module 210, a transmitting module 220, a receiving module 230 and an adjustment module 240. For example, the data-transmission device 200 can operate on the electronic device 100. In another example, if the above-noted modules are functional modules that include computer-executable commands, these modules can be stored in the memory device 104.

According to one embodiment, the acquisition module 210 is configured to obtain the data to be sent. For example, the data to be sent can be audio data. As an example, voice signals entered through the microphone 105 are recorded and converted into audio data through the audio circuit 110. In another example, the data to be sent can be video data. Video signals entered through the camera module 116 are recorded and converted into video data. In yet another example, the data to be sent can also be stored in advance in the memory device 104. In yet another example, the obtaining the data to be sent includes extracting the data from a file. The data to be sent can also be processed through conversion operations such as compression or encryption, in some embodiments.

According to another embodiment, the transmitting module 220 is configured to send the data to be sent to a reception terminal based on a network protocol. The network protocol can, for example, be a User Data Protocol (UDP). As an example, the reception terminal corresponds to the server 20. For example, in Peer to Peer (P2P) transmission, the reception terminal can be another electronic device. In another example, the data to be sent can be sent through the transmission module 106.

According to yet another embodiment, the receiving module 230 is configured to receive statistical data associated with the packet-loss rate returned by the reception terminal. For example, the statistical data associated with the packet-loss rate can directly be the packet-loss rate, or data used to compute the packet-loss rate such as the number of data packets received.

In one embodiment, the adjustment module 240 is configured to cause the transmitting module 220 to enter an enhanced-transmission mode if the packet-loss rate exceeds a pre-determined threshold. Otherwise, the transmitting module 220 changes into or maintains a normal-transmission mode. For example, the enhanced-transmission mode refers to transmitting the data to be sent multiple times. The number of repeated transmission can be set based on specific needs. For example, the packet-loss rate can be reduced significantly with two repeated transmissions. As an example, under extremely poor network conditions, the number of repeated transmissions can be gradually increased until the packet-loss rate is reduced to an acceptable range which is lower than the pre-determined threshold.

In another embodiment, the enhanced-transmission mode refers to transmitting a portion of the data to be sent multiple times. For example, a value of 50% can be pre-determined, and only 50% of the data packets in the data to be sent are sent multiple times. As an example, the data packets of this pre-defined percentage can be evenly distributed in all the data packets in the data to be sent. As such, the packet-loss rate is reduced to the acceptable range under most situations and the network traffic is reduced, in some embodiments.

In some embodiments, the normal-transmission mode is different from the enhanced-transmission mode, and occupies smaller network traffic as compared to the enhanced-transmission mode. For example, the normal-transmission mode refers to sending all the data packets only once. In yet another example, the normal-transmission mode refers also to sending a portion of the data packets multiple times, but this portion of data packets is of a smaller percentage than the data packets sent repeatedly in the enhanced-transmission mode.

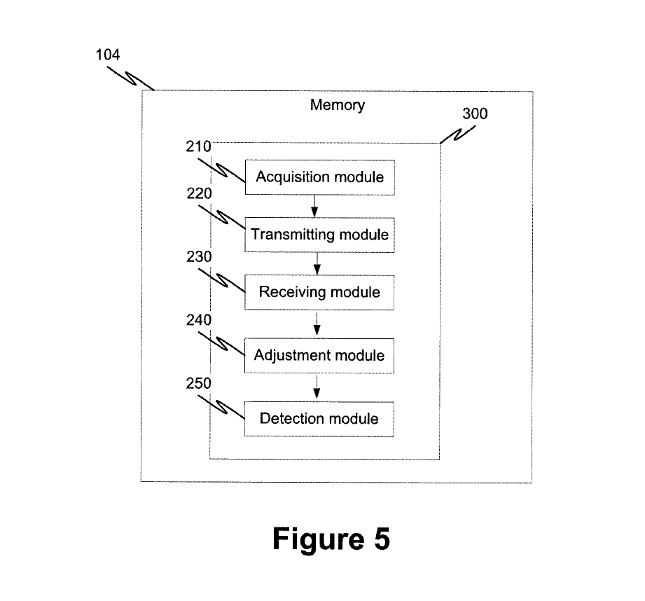

FIG. 5 is a simplified diagram showing a device for data transmission according to another embodiment of the present invention. This diagram is merely an example, which should not unduly limit the scope of the claims. One of ordinary skill in the art would recognize many variations, alternatives, and modifications. The data-transmission device 300 is similar to the data-transmission device 200 as shown in FIG. 2. The data-transmission device 300 further includes a detection module 250.

According to one embodiment, the detection module 250 is configured to detect whether the data to be sent is valid. For example, if detection module 250 detects that the data to be sent is valid, the adjustment module 240 then causes the transmitting module 220 to enter into the enhanced-transmission mode. As an example, if audio data contains only background sound data, its impact on the quality of voice calls is minimal and a high packet-loss rate will not affect the quality of voice calls. The audio data can be considered invalid and even if the packet-loss rate exceeds the pre-determined threshold, such audio data is not sent repeatedly so that the network traffic can be reduced. In yet another example, if one or more images in video data remains unchanged for a long period of time, such images in the video data are considered invalid and even if the packet-loss rate exceeds the pre-determined threshold, such data is not sent repeatedly so that the network traffic is reduced. The device 300 is configured to enter into the enhanced-transmission mode only when the data to be sent is valid so as to reduce the network traffic, in some embodiments.

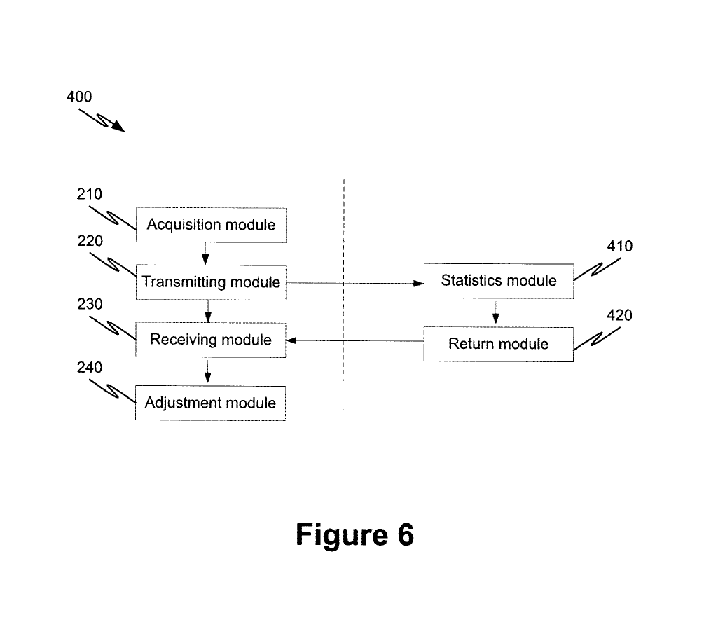

FIG. 6 is a simplified diagram showing a system for data transmission according to one embodiment of the present invention. This diagram is merely an example, which should not unduly limit the scope of the claims. One of ordinary skill in the art would recognize many variations, alternatives, and modifications. The data-transmission system 400 includes: an acquisition module 210, a transmitting module 220, a statistics module 410, a return module 420, a receiving module 230 and an adjustment module 240. For example, the acquisition module 210, the transmitting module 220, the receiving module 230 and the adjustment module 240 are shown in FIG. 4 and/or FIG. 5.

According to one embodiment, the statistics module 410 and the return module 420 are located in the reception terminal (e.g., the server 20). For example, the statistics module 410 is configured to compute a packet-loss rate based on received data. In another example, the return module 420 is configured to return the packet-loss rate to the client (e.g., the first client 21).

According to another embodiment, a method is provided for data transmission. For example, first data to be sent is obtained; the first data is sent to a reception terminal; second data related to a packet-loss rate returned by the reception terminal is received; and in response to the packet-loss rate exceeding a pre-determined threshold, at least a portion of the first data is sent multiple times. For example, the method is implemented according to at least FIG. 3.

According to yet another embodiment, a data transmission device includes: an acquisition module, a transmitting module, a receiving module and an adjustment module. The acquisition module is configured to obtain first data to be sent. The transmitting module is configured to send the first data to a reception terminal. The receiving module is configured to receive statistical data related to a packet-loss rate returned by the reception terminal. The adjustment module is configured to, in response to the packet-loss rate exceeding a pre-determined threshold, cause the transmitting module to send at least a portion of the first data multiple times. For example, the device is implemented according to at least FIG. 4, FIG. 5, and/or FIG. 6.

According to yet another embodiment, a method is provided for data transmission. For example, first data to be sent is obtained at the client; the first data is sent by the client to a reception terminal based on at least information associated with a network protocol; second data related to a packet-loss rate is computed by the reception terminal based on at least information associated with the first data; the second data related to the packet-loss rate is sent by the reception terminal to the client; whether the packet-loss rate exceeds a pre-determined threshold is determined by the client based on at least information associated with the second data; and in response to the packet-loss rate exceeding the pre-determined threshold, at least a portion of the first data is sent by the client multiple times. For example, the method is implemented according to at least FIG. 3.

In one embodiment, a data transmission system includes: an acquisition module, a transmitting module, a statistics module, a return module, a receiving module and an adjustment module. The acquisition module is configured to obtain at a client first data to be sent. The transmitting module is configured to send the first data to a reception terminal based on at least information associated with a network protocol. The statistics module within the reception terminal is configured to compute second data related to a packet-loss rate based on at least information associated with the first data. The return module is configured to return the second data related to the packet-loss rate to the client. The receiving module is configured to receive the second data related to the packet-loss rate returned by the reception terminal. The adjustment module is configured to, in response to the packet-loss rate exceeding a pre-determined threshold, cause the transmitting module to send at least a portion of the first data multiple times. For example, the system is implemented according to at least FIG. 6.

In another embodiment, a non-transitory computer readable storage medium includes programming instructions for data transmission. The programming instructions are configured to cause one or more data processors to execute certain operations. For example, first data to be sent is obtained; the first data is sent to a reception terminal; second data related to a packet-loss rate returned by the reception terminal is received; and in response to the packet-loss rate exceeding a pre-determined threshold, at least a portion of the first data is sent multiple times. For example, the storage medium is implemented according to at least FIG. 3.

In yet another embodiment, a non-transitory computer readable storage medium includes programming instructions for data transmission. The programming instructions are configured to cause one or more data processors to execute certain operations. For example, first data to be sent is obtained at the client; the first data is sent by the client to a reception terminal based on at least information associated with a network protocol; second data related to a packet-loss rate is computed by the reception terminal based on at least information associated with the first data; the second data related to the packet-loss rate is sent by the reception terminal to the client; whether the packet-loss rate exceeds a pre-determined threshold is determined by the client based on at least information associated with the second data; and in response to the packet-loss rate exceeding the pre-determined threshold, at least a portion of the first data is sent by the client multiple times. For example, the storage medium is implemented according to at least FIG. 3.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for data transmission, comprising:
obtaining first data to be sent;
sending the first data to a reception terminal;
receiving second data related to a packet-loss rate returned by the reception terminal; and
in response to the packet-loss rate exceeding a pre-determined threshold, sending at least a portion of the first data multiple times.

2. The method of claim 1, wherein the sending at least a portion of the first data multiple times includes: sending the first data multiple times.

3. The method of claim 1, wherein:
the first data includes multiple first data packets; and
the at least a portion of the first data includes one or more second data packets, the second data packets corresponding to a pre-determined percentage of the first data packets.

4. The method of claim 3, wherein the second data packets are evenly distributed in the first data packets.

5. The method of claim 1, further comprising:
detecting whether the first data is valid; and
in response to the first data being valid, sending the at least a portion of the first data multiple times.

6. The method of claim 1, wherein the reception terminal includes a voice server.

7. A data transmission device comprising:
an acquisition module configured to obtain first data to be sent;
a transmitting module configured to send the first data to a reception terminal;
a receiving module configured to receive statistical data related to a packet-loss rate returned by the reception terminal; and
an adjustment module configured to, in response to the packet-loss rate exceeding a pre-determined threshold, cause the transmitting module to send at least a portion of the first data multiple times.

8. The device of claim 7, wherein the adjustment module is further configured to cause the transmitting module to send the first data multiple times.

9. The device of claim 7, wherein:
the first data includes multiple first data packets; and
the at least a portion of the first data includes one or more second data packets, the second data packets corresponding to a pre-determined percentage of the first data packets.

10. The device of claim 9, wherein the second data packets are evenly distributed in the first data packets.

11. The device of claim 7, further comprising:
a detection module configured to detect whether the first data is valid;
wherein the adjustment module is further configured to, in response to the first data being valid, cause the transmitting module to send the at least a portion of the first data multiple times.

12. The device of claim 7, wherein the reception terminal includes a voice server.

13. The device of claim 7, further comprising:
one or more data processors; and
a computer-readable storage medium;
wherein one or more of the acquisition module, the transmitting module, the receiving module and the adjustment module are stored in the storage medium and configured to be executed by the one or more data processors.

14. A method for data transmission, comprising:
obtaining, at the client, first data to be sent;
sending, by the client, the first data to a reception terminal based on at least information associated with a network protocol;
computing, by the reception terminal, second data related to a packet-loss rate based on at least information associated with the first data;
sending, by the reception terminal, the second data related to the packet-loss rate to the client;
determining, by the client, whether the packet-loss rate exceeds a pre-determined threshold based on at least information associated with the second data; and
in response to the packet-loss rate exceeding the pre-determined threshold, sending, by the client, at least a portion of the first data multiple times.

15. A data transmission system comprising:
an acquisition module configured to obtain at a client first data to be sent;
a transmitting module configured to send the first data to a reception terminal based on at least information associated with a network protocol;
a statistics module within the reception terminal configured to compute second data related to a packet-loss rate based on at least information associated with the first data;
a return module configured to return the second data related to the packet-loss rate to the client;
a receiving module configured to receive the second data related to the packet-loss rate returned by the reception terminal; and
an adjustment module configured to, in response to the packet-loss rate exceeding a pre-determined threshold, cause the transmitting module to send at least a portion of the first data multiple times.

16. The system of claim 15, further comprising:
one or more data processors; and
a computer-readable storage medium;
wherein one or more of the acquisition module, the transmitting module, the statistics module, the return module, the receiving module and the adjustment module are stored in the storage medium and configured to be executed by the one or more data processors.

17. A non-transitory computer readable storage medium comprising programming instructions for data transmission, the programming instructions configured to cause one or more data processors to execute operations comprising:
obtaining first data to be sent;
sending the first data to a reception terminal;
receiving second data related to a packet-loss rate returned by the reception terminal; and
in response to the packet-loss rate exceeding a pre-determined threshold, sending at least a portion of the first data multiple times.

18. A non-transitory computer readable storage medium comprising programming instructions for data transmission, the programming instructions configured to cause one or more data processors to execute operations comprising:
obtaining first data to be sent;
sending the first data to a reception terminal based on at least information associated with a network protocol;
computing second data related to a packet-loss rate based on at least information associated with the first data;
sending the second data related to the packet-loss rate to the client;
determining whether the packet-loss rate exceeds a pre-determined threshold based on at least information associated with the second data; and
in response to the packet-loss rate exceeding the pre-determined threshold, sending at least a portion of the first data multiple times.
